(19) United States
(12) Patent Application Publication
(10) Pub. No.: US 2006/0274720 A1
(43) Pub. Date: Dec. 7, 2006

(54) Systems and methods for multicast routing on packet switched networks

(76) Inventors: Andrew Adams, Ann Arbor, MI (US); Chris Brown, Plymouth, MI (US); Disha Chopra, Ann Arbor, MI (US); Bisong Tao, San Jose, CA (US); Vijaya Sheppillayar, Livermore, CA (US); Leisheng (Eric) Ji, Fremont, CA (US); William Siadak, New Boston, MI (US)

Correspondence Address: PERKINS COIE LLP, P.O. BOX 2168, MENLO PARK, CA, 94026, US

(21) Appl. No.: 11/271,698

(22) Filed: Nov. 9, 2005

Related U.S. Application Data
(60) Provisional application No. 60/626,816, filed on Nov. 9, 2004.

(51) Int. Cl. H04L 12/28; H04J 3/22

(52) U.S. Cl. 370/351; 370/465

(57) ABSTRACT

A system architecture is described for supporting protocol independent multicast routing and local group membership multicast protocols concurrently and consistently within a multi-cast border router on a packet switched network.

### CLAIM OF PRIORITY

This application claims priority to U.S. Provisional Application No. 60/626,816, entitled “Systems and Methods for Multi-Cast Routing,” filed Nov. 9, 2004, inventors Adams, et al., which is hereby incorporated by reference in its entirety. This application is also related to U.S. patent application Ser. No. 11/121,162, entitled “Virtualization of Control Software for Communication Devices,” filed May 2, 2003, inventor, Chu, et al., which is hereby incorporated by reference in its entirety.

### FIELD OF THE INVENTION

The invention relates to the field of network communication, and more particularly to systems for facilitating distribution of data on packet-switched networks.

### BACKGROUND OF THE INVENTION

Communication of phones, laptops and cell phone over a network is part of daily life for North America, Europe and Korea. The demand for more bandwidth and network devices continues to grow. However, Moore's law suggests a limit to how fast hardware can grow.

Virtualization software enables one physical device to become 10s or 100s of logical devices. This type of instance growth provides a way around the limits in hardware growth. Examples of virtualization software include VM Ware 4.0 or VPC2004. The virtualization of end systems is based on some knowledge of what are critical systems for applications and what systems can wait.

Network communication software is that aids in communication over the network. Communication software may pass data, voice, multi-media or signaling. Such data traffic can be switched at layer 2 or routed at layer 3 or routed/forwarded at layer 4 and higher. Network software has constraints on timing, data throughput and processing that render virtualization requirements different than ordinary PC management.

Virtualization software for network communication requires careful modular software engines for network communications. Modular software engines with well-defined Application Programming Interfaces (APIs) provide software frameworks that network protocols can employ. Modular software engines can provide highly efficient communication between modules plugged into the software engine. Careful modularization of protocols can allow quick additions of new features and ease debugging. Due to the pace of change in the Internet, quick addition of features and functions is key to quick adaptation to new environments.

A communication device operates on a network to perform some application. Many networks are connected together via the Internet. Information in the Internet is transmitted as packets. A packet in the Internet is a fixed-length piece of data that is individually routed hop-by-hop from source to destination. The action of routing a packet means that each router along the path examines header information in the packet and a local database in order to forward the packet to its next hop.

This local database is typically called the Forwarding Information Base or FIB. Entries in the FIB, usually structured as a table, determine where packets are to be forwarded. The FIB is derived from a collective database called a Routing Information Database or RIB. This RIB is a collection of all the routing information the router “knows”; an algorithm maps the entries (routes) in the RIB to those in the FIB, which is used for forwarding. The RIB supports two different types of FIBs: unicast and multicast.

The unicast FIBs supports the forwarding of packets with a specific Unicast destination address. Unicast forwarding sends one packet from one source to one destination. Multicast forwarding supports the forwarding of packets from one source to multiple destinations. Each of the destinations receiving the data are called “receivers”. Each multicast receiver requests data for a particular “group”, and optionally from a particular source.

Multicast state includes information per source-multicast group pair. To limit the amount of information each network device is required to keep, the multicast information is “cached” in a “Multicast Forwarding Cache” (MFC).

Forwarding information for IPv4 requires different storage than forwarding information for IPv6. Network devices keep unicast FIB for both IPv4 and IPv6. MFCs are kept for both IPv4 and IPv6. Kernels employ APIs that allow the downloading of these forwarding tables from the control plane process that calculate routes to the forwarding processes in cards or operating systems. An example of a protocol that is used to download the FIBs is the “netlink2” protocol.

Another method is the socket API for IPv6 multicasting defined by the Basic Socket interface extensions for IPv6 (RFC 2553).

Routing Protocols

The RIB (both Unicast and Multicast parts) is built in two ways, which may be used together: (a) static configuration, and (b) dynamic routing protocols. Unicast dynamic routing protocols may be further subdivided into two groups based on the part of the Internet in which they operate: exterior gateway protocols, or EGPs, are responsible for the dissemination of routing data between autonomous administrative domains, and interior gateway protocols, or IGPs, are responsible for dissemination of routing data within a single autonomous domain. Furthermore, two types of IGPs are in widespread use today: those that use a distance-vector type of algorithm and those that use the link-state method.

Multicast routing protocols pass enough information to create a “multicast forwarding tree” at each node in a multicast area (also called a domain). To reduce loops, some multicast routing protocol utilize a Reverse Path Forwarding (RPF) check to determine the shortest path to the source. The RPF checks allow the multicast forwarding trees to be minimized.

The Multicast Routing protocols can also be further subdivided into: protocol-independent multicast routing protocols and protocol-dependent multicast tree growing protocols. Both Protocol independent multicast routing protocols use the routing information passed by Unicast protocols (EGP or IGP) to perform the RPF check. Protocol Independent multicast is an example set of protocols that use the Unicast protocols (IGP or EGP) to carry information about the multicast trees. PIM has three sub-protocols: PIM for Sparse Mode (PIM-SM), PIM for Dense mode (PIM-DM), and PIM-SSM (Source Specific Multicast). Protocol-dependent multicast protocols carried the connectivity information in the multicast protocols. An example of such a protocol is DVMRP.

PIM-SM and PIM-DM may support any sources to a given group. This is called Any Source Multicast (ASM). PIM-SSM supports sending by specific sources to multicast groups (SSM).

A third part of the multicast protocol suite is the Local Group Membership (LGM) protocols such as multicast static, IGMPv3, and MLDv2. Software modules supporting Local Group Membership, also referred to as Local Group Membership Modules (LGMMs) allow hosts to communicate group members to multicast routers.

IGMP version 2 (IGMPv2) provided a mechanism by which IPv4 host machines could signal their desire to receive multicast data address to a specific multicast group. IGMP version 3 (IGMPV3) expanded upon this basic concept to include the notion of “INCLUDE” and “EXCLUDE”. In “INCLUDE” mode, a host can signal a desire to receive multicast data addressed to a specific multicast group, and sent by specific set of sources. In Exclude mode, it can express the desire to receive traffic sent to a particular multicast group from all sources except certain sources. MLD version 2 provides the same mechanism for IPv6 hosts.

Communication Devices

A communication device operates on a network to perform some application. Common network or communication devices running applications include: firewalls, route-servers, network-access devices and network-management devices.

Firewalls are network devices that run a security analysis on the traffic that is passed through them. Route-Servers are devices that store routes from many different networks and upon request provide information about these routes. Network Access devices provide local access to a network via a particular type of physical interface such as Ethernet, Dial-up, or long-haul circuits.

Network Management devices monitor and configure the network. The network manager may monitor a network for failures (faults) or performance (how many packets) or accounting issues (login access by customer or security attacks).

Border Router Devices

Network devices can run different routing protocols on different interfaces. For instance, OSPF and BGP may run on one interface and ISIS on a different interface on the same network device. Multicast can run PIM-DM on one interface, DVMRP on a second, and PIM-SM on a third. Network devices may operate the edge of one protocol's domain. If it interacts with other domains, it is called “border” router. For example, BGP operates on the edges of Autonomous System as EGP router and is called a border router. In the same way, network devices operating on the edge of multicast protocol domains are “multicast border routers.”

Interoperability rules for multiple multicast routing protocols running in the same box are specified in RFC 2715. RFC 2715 describes a system of events that allow different multicast protocols to efficiently interact while running on the same router, often referred to as a “Multicast Border Router” or “MBR”. RFC 2715 applies to multicast border routers that meet the following assumptions stated in the RFC:
The MBR has two or more active multicast routing components, each running an instance of some multicast routing protocol.
Multiple components running the same protocol are allowed.
The router is configured to forward packets between two or more independent multicast domains. The router has one or more active interfaces in each domain, and one component per domain.
The router also has an inter-component “alert dispatcher”. The dispatcher is responsible for selecting, for each (S,G) entry in the shared forwarding cache, the component owning the in-coming interface. It is also responsible for selecting to which component(s) a given alert should be sent.
RFC 2715 specifies that an alert is a logical method that implementation-dependent function. Originators of an alert are also implementation specific.
Only one multicast routing protocol is active per interface. Each interface on which multicast is enabled is thus “owned” by exactly one of the components.
All components share a common forwarding cache of (S,G) entries, which are created when data packets are received, and can be deleted at any time. Only the component owning an interface may change information about that interface in the forwarding cache.
Each forwarding cache entry has a single incoming interface (iif) and a list of outgoing interfaces (oiflist).
Each component typically keeps a separate multicast routing table with any type of entries.
   Per RFC 2715, the MBR router obeys the following rules:
Rule 1: All components agree on which component owns the incoming interface (iif) for a forwarding cache entry. This component, referred to as the the “iif owner” is determined by a “dispatcher”. The incoming component may select ANY interface it owns according to its own rules.
Rule 2: The component owning an interface specifies the criteria for which packets received on that interface are to be accepted or dropped (e.g., whether to perform an RPF check, and what scoped boundaries exist on that interface). Once a packet is accepted, however, it is processed according to the forwarding rules of all components.
   Furthermore, some multicast routing protocols (e.g. PIM) also require the ability to react to packets received on the “wrong” interface. To support these protocols, an MBR allows a component to place any of its interfaces in “WrongIf Alert Mode”. If a packet arrives on such an interface, and is not accepted according to Rule 2, then the component owning the interface is alerted [(S,G) WrongIf alert]. Typically, WrongIf alerts must be rate-limited.
Rule 3: Whenever a new (S,G) forwarding cache entry is to be created (e.g., upon accepting a packet destined to a non-local group), all components are alerted [(S,G) Creation alert] so that they can set the forwarding state on their own outgoing interfaces (oifs) before the packet is forwarded.
   Note that (S,G) Creation alerts are not necessarily generated by one of the protocol components themselves.
Rule 4: When a component removes the last oif from an (S,G) forwarding cache entry whose iif is owned by another component, or when such an (S,G) forwarding cache entry is created with an empty oif list, the component owning the iif is alerted [(S,G) Prune alert] (so it can send a prune for example).
Rule 5: When the first oif is added to an (S,G) forwarding cache entry whose iif is owned by another component, the component owning the iif is alerted [(S,G) Join alert] (so it can send a join or graft, for example).
   The oif list in rules 4 and 5 must also logically include any virtual encapsulation interfaces such as those used for tunneling or for sending encapsulated packets to an RP/core.
Rule 6: Unless a component reports the aggregate group membership in the direction of its interfaces, it will be a “wildcard receiver” for all sources whose RPF interface is owned by another component (“externally-reached” sources). In addition, a component will be a “wildcard receiver” for all sources whose RPF interface is owned by that component (“internally-reached” sources) if any other component of the MBR is a wildcard receiver for externally-reached sources; this will happen naturally as a result of Rule 5 when It receives a (*,*) Join alert.
   Inadequacies of Prior Art

RFC 2715 defines the concept of protocol components, but the prior art does not include a canonical Application Programming Interface (API) for implementing MBR functionality in network devices. Furthermore, while RFC 2715 describes in general the system of events that allow different multicast protocols to interact, it does not specifically address methods to allow the source specific “include” or “exclude” functionality provided by LGMM modules: multicast static routes, IGMPv3, or MLDv2. Without the changes to the basic functionality to the MBR functionality, multicast routing protocols such as PIM-SM and PIM-DM cannot properly respond to the situation where, for example, a local receiver wishes to receive only multicast traffic originated by sender S and address to Any Source Multicast group (ASM).

The prior art, including RFC 2715, does not address the INCLUDE/EXCLUDE policy methods to govern the inter-connecting the Local Group Membership Modules and protocol components. This lack of functionality introduces, as an example, obstacles in the use of IGMPv3 with PIM-SM.

Thus, the prior art evinces a need to:

inter-connect LGMM and Protocol Components
scale multicast alerts by providing a centralized point to handle alerts,
centralize the distribution of MFC information to software kernels of the applicable network devices as well as over layer 2 protocols.
Provide an API that includes: both basic MBR functionality and the source specific include or exclude policy for IPv4 and IPv6
methods to provide efficient configuration of MBR routers.

These and other inadequacies of the prior art are addressed by the invention as set forth herein.

### SUMMARY OF THE INVENTION

The invention presents architectures, methods, and APIs for a multicast communication environment. The invention enables multicast routing protocol component modules and Local Group Membership Modules (LGMM) to run in collaborative fashion to support flexible multicast forwarding based on policy communication devices such as firewalls, routers, switches, mobile environments, security gateways, or network access equipment. Current examples of LGMM protocols supported by the invention include mstatic, IGMPv3 and MLDv2, and current examples of multicast routing protocols supported by the invention include PIM-SM, PIM-DM, PIM-SSM, and DVMRP. Many other examples of both types of protocols that are supported by the invention shall be readily apparent to those skilled in the art. In embodiments of the invention, the LGM and multicast routing protocols are operative on routers on packet switched networks that support multicasting, such as Multicast Border Routers, or MBRs.

An API contained in embodiments of the invention facilitate communication and coordination between software modules on network devices supporting Local Group Membership (LGMMs), software modules on such network devices supporting routing protocols, and multi-cast forwarding caches, which store state information for source—multicast group pairs.

In embodiments of the invention, the API provides a clean canonical interface that allows the multicast processes to be run in a virtual communications environment that may span modules within process, across multiple processes, or across multiple processes in multiple machines. In some embodiments, support for the multicast and LGM protocols may be contained in a single process resident on a multicast border router.

These and other embodiments of the invention are described in further detail herein.

### BRIEF DESCRIPTION OF DIAGRAMS

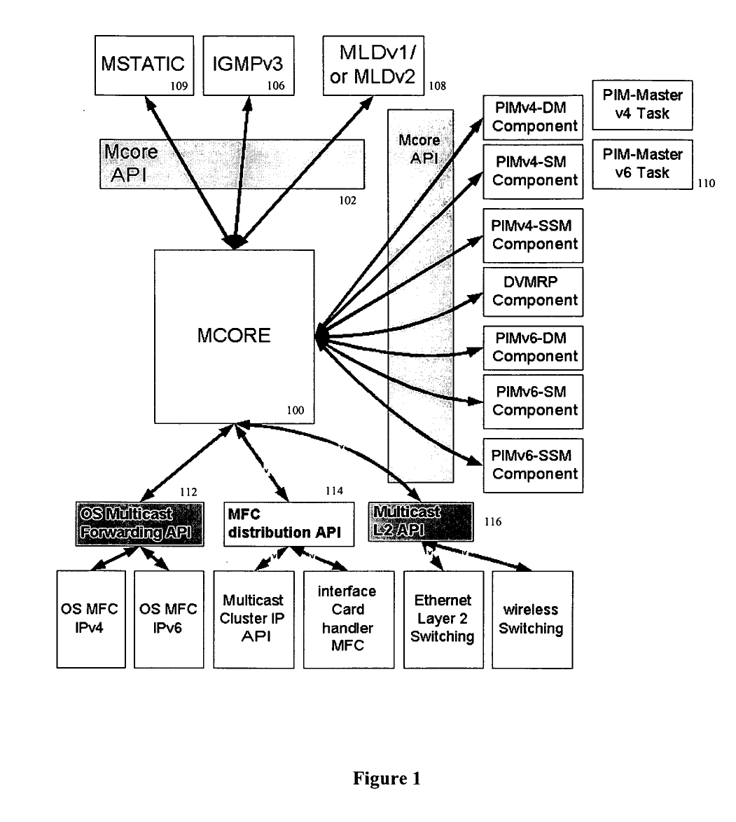

FIG. 1 illustrates a system architecture for a multicast hardware router in accordance with embodiments of the invention.

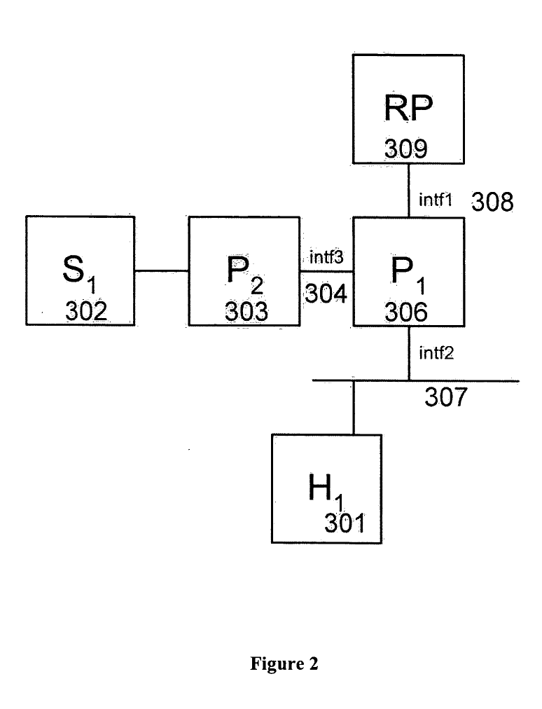

FIG. 2 illustrates a non-limiting example of a network architecture supporting multicast routing in accordance with embodiments of the invention.

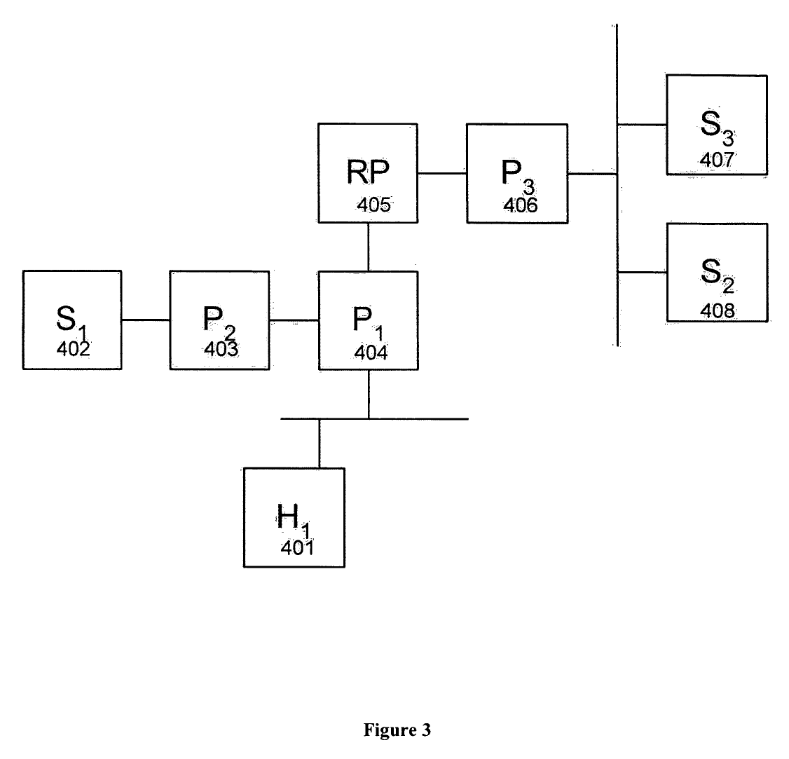

FIG. 3 illustrates another non-limiting example of a network architecture supporting multicast routing in accordance with embodiments of the invention.

### DETAILED DESCRIPTION

The invention presents a framework and canonical methods, and canonical interface methods (APIs) for a multicast communication environment. This multicast communication environment supports the running of multicast routing protocol component modules and Local Group Membership Modules (LGMM) in collaborative fashion to support flexible multicast forwarding based on policy. Embodiment of this invention supports LGMM modules for multicast static routes, IGMPv3, and MLDv2, and multicast routing protocols: PIM-SM, PIM-SSM, PIM-DM, and DVMRP. Non-limiting examples of communication devices supported by the invention includes: firewalls, routers, switches, mobile environments, security gateways, and network access equipment. Other examples shall be readily apparent to those skilled in the art.

Embodiments of the invention provide methods that allow the Multicast Border Router with multiple Local Group Membership Modules (LGMM) to communicate with multiple multicast routing protocol modules. As an illustrative, non-limiting example, embodiments of MBRs in accordance with the invention may include 2 LGMMs (such as, by way of non-limiting example, IGMPv3 and MLDV2) communicating with multiple protocol components (such as, by way of non-limiting example, PIM-SM, PIM-DM, DVMRP, PIM-SSM).

FIG. 2 illustrates a non-limiting example of multi-cast networks on which the invention may operate. As non-limiting, illustrative example of the invention, consider the multicast group depicted in FIG. 2, which depicts a network node 309 referred to as a Rendezvous Point (RP), at which multicast sources and receivers are stored in a tree-based data structure referred to as a RP Tree. The RP is in communication with a network node P1 306 supporting a protocol independent multicast protocol, such as, by way of non-limiting example, PIM-SM. The RP 309 and P1 306 are in communication via a first interface for P1 labeled “intf1” 308. FIG. 2 further depicts a receiver node, H1 301, a second node P2 303 supporting PIM-SM or such other PIM, and a source node S1 302.

Suppose that H1 30 is running an LGM, such as, by way of non-limiting example, IGMPv3.

In this example H1 (301) subscribes to channel (S1, G), where G is a Source Specific Multicast Group, or SSM by sending an IGMPv3 Membership Report, ALLOW (S1) for group G. Embodiments of the invention allow P1 data for the SSM group to be retrieved by H1 301 and the other nodes via the RP tree contained in RP 309.

Another example is illustrated in FIG. 3. S1 402, S2 407 and S3 408 are all senders to the ASM group G. P1 404, P2 403 and P3 406 are PIM-SM routers.

H1 401 begins by sending a Membership Report, EXCLUDE(S2), which P1 (404) receives. P1 404 triggers a PIM-SM (*,G) Join towards RP, along with an (S2,G,RPT) prune. Embodiments of the invention ensure that:
traffic from sources S₁ 402 and S₃ 403 addressed to group G will arrive at P₁ 404 and be forwarded to H1 401.
Traffic from S₂ will be pruned at RP 405.

This traffic behavior cannot occur unless the MBR rules and MBR alerts are extended to handle exclude functionality.

Embodiments of the invention include the following aspects:

Extensions to Multicast Border Routing Methods

Embodiments of the invention include methods that support INCLUDE/EXCLUDE operations on multicast border routers that include both Local Group Membership Modules and components for multicast routing protocol components. In some such embodiments, if an LGMM protocol on a Multicast Border Router owns or controls an interface on such MBR, the LGMM signals a request to include or exclude (as applicable) sources for specific groups on such interface to all multicast routing modules on the MBR.

Embodiments of the invention further include methods for generating alerts to protocols with the following steps:
1. Protocol components on an MBR register to receive alerts and extended alerts for LGMM interfaces
2. Due to LGMM interactions, alerts are sent to the protocol components that own or control an interface on the MBR. The extended alerts that the LGMM interactions can cause include:
   “Aux Ex-Prune alert”—in embodiments of the invention, an LGMM sends this alert when the group members mode is Exclude on some interface and it is determined that no hosts on the interface desire to receive group traffic from a specific source. An Aux Ex-Prune alert puts the interface in to Aux-Ex Prune state.
   “Aux Ex-Join alert”—This alert is generated by the LGMM when the group membership mode is EXCLUDE on some interface and it is determined that hosts that had desired to not receive group traffic from a specific source now desire such traffic or when other reasons as determined by LGMM occur such that Aux Ex-Prune state should be cancelled.
      Canonical Methods for Interaction Amongst Local Group Membership and Protocol Independent Routing Modules

Embodiments of the invention include methods to support LGMM modules with source-specific policy and multicast routing protocol components for multiple address families. A software architecture used on MBRs to support such interaction is depicted in FIG. 1. In embodiments of the invention, this architecture enables:
Interaction with a canonical MFC forwarding API supports that handles multiple address families,
Interaction with a canonical MFC distribution API that supports cluster environments or exporting MFCs outside of the MBRs
Interaction with a canonical Layer 2 MFC to support L3/L2 interactions for Multicast forwarding.

In embodiments of the invention, this canonical API supports updating with a single API MFC for IPv4 and MFC for IPv6. As a non-limiting example, the API may include the following functions
Enable multicast forwarding
   Call: void mforwarding_disable(int af)
   Function: This function is called to disable multicast forwarding for the given address family
Adding a Multicast Interface
   Call: int mforwarding_add_if(if_addr *ifap)
   Function: This function is called to enable multicast forwarding on the logical interface for the MBR.
Deleting a Multicat interface
   Call: void mforwarding_del_if(if_addr *ifap)
   Function: This function is called to disable multicast forwarding on the logical interface
Adding a Multicast Forwarding Cache Entry
   Call: int mforwarding_add_cache(sockaddr_un *gaddr, sockaddr_un *saddr)
   Function: This function is called to add a multicast forwarding cache entry.
Removing a Multicast Forwarding Cache Entry
   Call: int mforwarding_del_cache(sockaddr_un *gaddr, sockaddr_un *saddr)
   Function: This function is called to remove a multicast forwarding cache entry
Obtaining S,G Forwarding Counts
   Call: int mforwarding_src_stat(source_t *src)
   Function: This call obtains the statistics on the (S,G) packets forwarded

Embodiments of the invention include methods for MFC updates to allow multicast protocols to run on a cluster structure. Such methods may check for external cluster addresses references in any of the interfaces to the MBR. Embodiments use a macro referred to as IFA_EXTERNAL_ADDR to determine a local address or the cluster address to be used. This method allows the substitution of the cluster address into multicast routing messages sent on a cluster interface. This method also allows storage of the cluster IP address for BSR election, Simultaneous CBSR/CRP Configuration, and Assert processing.

In embodiments of the invention, for prune and flood protocols such as PIM-DM, the graft and graft ack messages processes uses the cluster IP address to do interface checks and tie-breaks. In some such embodiments, if the cluster IP address is configured on a local interface, this address is used to generate and check the state refresh.

Data Structures

The invention utilizes a tree, of (G,S) or (S,G) data structures, more specifically:
(G,S)— a multicast routing tree (mrt) of (Groups, Sources) is a tree of groups each of which link to sources (shown in diagram x-1)
(S,G)—a mrt of (S,G) is a tree of Sources each of which link to groups (shown in diagram x-2)

To aid in processing LGMM source specific policy, this invention adds the following data structures.

Enhancment of (S,G) structure to allow storage of component interest at group level. The “grpinterest” flag has been added.

typedef struct comp_group_{—} {

| | |
|---|---|
| sockaddr_un * | addr; |
| sockaddr_un * | mask; |
| mrt_node_t * | node; |
| mrt_table_t * | sources; |
| flag_t | grpinterest; /* Changed */ |

} comp_group_t;

Enhancment of (S,G) to include a group interest

typedef struct comp_group_{—} {

| | |
|---|---|
| sockaddr_un * | addr; |
| sockaddr_un * | mask; |
| mrt_node_t * | node; |
| mrt_table_t * | sources; |
| flag_t | grpinterest; /* Changed */ |

} comp_group_t;

SG tree of (Source, Groups, Interface)—per interface lists of Groups operating on the interface linked to sources sending to those groups (abbreviated as (S,G,I)).

The SG Table container The SG Table (SGT) is a container for storing information about (S,G) pairs that has the property that given S₁ one may obtain all pairs (S₁,G₁) . . . (S₁,Gₙ) in O(N) time where N is the number of groups. This contrasts with the Multicast Routing Table (MRT) container that has the property that given G₁ one may obtain all pairs (S₁,G₁) . . . (Sₙ,G₁) in O(N) time where N is the number of sources.

An MRT is best used in when one wishes to perform operations on all (S,G) entries for the same group. In contrast, an SGT is best used when one wishes to perform operations on all (S,G) entries for the same source.

SG Include Table

The SG Include Table (SGIT) is a container for recording a component's desire to receive data from a specific source addressed to a specific group when the route to the source is known and the RPF_Interface(S) is owned by any multicast component.

In some such embodiments the SGIT has an SGT container in which to store the (S,G) entries that meet the above two conditions. The data stored at each (S,G) entry in the SGT is a bit vector of components that have registered include for the (S,G).

SG Include Null Table

The SG Include Null Table (SGINT) is a container for recording a component's desire to receive data from a specific source addressed to a specific group when the route to the source is unknown or the RPF_Interface(S) is not owned by any multicast component. These are the components that do not meet the conditions for entry in the SGIT.

In this embodiment, the SGINT has an SGT container in which to store the (S,G) entries that meet the above two conditions. The data stored at each entry in the SGT is a bit vector of components that have registered include.

SG Aux Include Table (SGAIT)

The SG Aux Include Table (SGAIT) is a container for recording the LGMM's desire to receive data from a specific source addressed to a specific group on a specific interface—an (S,G,I) tuple—when the route to the source is known and the RPF_Interface(S) is owned by any multicast component.

In an embodiment, the SGAIT has an SGT container in which to store the (S,G) entries that meet the above two conditions. The data stored at each entry in the SGT is a paticia trie of interfaces that have sent the join alert.

SG Aux Include Null Table (SGAINT)

The SG Aux Include Null Table (SGAINT) is a container for recording the LGMM's desire to receive data from a specific source addressed to a specific group on a specific interface—an (S,G,I) tuple—when the route to the source is unknown or the RPF_Interface(S) is not owned by any multicast component. These are the components that do not meet the conditions for entry in the SGAIT.
mrt-tree of (Host, Sources, Groups, interfaces)—per interface of Hosts associated with the interfaces for multicast Groups with sources sending to those groups (H,S,G,I)
igmp data structure that combines (S,G,I) data structure with (H,S,G,I) data structures
Use of Calendar queues to store timing information per interface
   Software Architecture

FIG. 1 depicts a virtual communication architecture used in embodiments that includes the following elements:
Mcore 100—The Core routines that store multicast state in trees and handle inter-module communication.
LGMM modules 104 106-108 protocol modules supporting LGM
Component modules—application modules 110 operating as a functional module within the vEngine code module.
Mcore API 102—application programming interface to the Mcore module. This API includes: Mcore Alerts and MCORE API calls (for components and LGMMs).
OS Multicast Forwarding API 112: The API that updates the multicast forwarding state within a network level kernel (OSI layer 3). This API updates both IPv4 and IPv6 addresses.
Multicast Cluster IP API 114: An API that allows the Multicast address to work in a cluster environment.
Layer2 Switch API 116—Layer 2 Switch API that passes Multicast forwarding, Source, Group multicast information, and multicast policy to the layer 2 processes. These processes can be signaling or forwarding with wired or wireless processing.
   Canonical API

Embodiments of this invention method provides a canonical API to the MBR functionality in a multicast node (also referred to herein as an “Mcore” API). This also has functions to support storage of multicast tree structure.

The Canonical API provides functions including:
Alerts
Registration
Storage of Multicast routing information
Manipulation of interfaces
   API for Alerts and Registration of Alerts.

Embodiments of the invention provides a canonical API to the following types of Alerts for basic MBR functionality.

MBR(S,G) Creation alert—
API call: void (*sg_creation_recv_func) (task *tp, source_t *req)
Function: generated in response to a multicast packet arriving for which the source and group addresses matched no entry in the kernel MFC

MBR(S,G) Join alert
API call: void (*sg_join_recv_func) (task *tp, sockaddr_un *saddr, sockaddr_un *gaddr, if_addr *ifap)
Function: generated when an interface is added to the OIF list of an (S,G) entry, causing the OIF list to become non-null.

MBR(S,G) Prune Alert
API Call: void (*sg_prune_recv_func) (task *tp, sockaddr_un *saddr, sockaddr_un *gaddr)
Function: generated when an interface is removed from the OIF list of an (S,G) entry causing the OIF list to become null

MBR Group Join Alert—
API call: void (*grp_join_recv_func) (task *tp, sockaddr_un *gaddr, sockaddr_un *gmask)
Function: Generated when first component expresses interest in a particular group

MBR Group Prune Alert—
API call: void (*grp_prune_recv_func) (task *tp, sockaddr_un *gaddr, sockaddr_un *gmask)
Function: Generated when no components express interest in a particular group.

MBR (S,G) Deletion Alert—
API call: void (*sg_deletion_recv_func) (task *tp, source_t *src)
Function: Generated when another multicast component deletes an entry from the MBR's Multicast Routing Table (MRT).

MBR (S,G) Creation Alert—
API call: void (*sg_creation_recv_func) (task *tp, source_t *req)
Function: This alert is delivered to all registered components when a multicast packet received causes a MFC cache miss occurs.

MBR Wrong Interface Alert—
API Call: void (*sg_wrongif_recv_func) (sockaddr_un *saddr, sockaddr_un *gaddr, if_addr *ifap);
Function: Generated when a multicast packet arrives on an interface other than the one given for the matching entry in the kernel's MFC.

Embodiments of the invention include one or more of the following Extended API Calls for extended support of MBR functions:

MBR Aux Join Alert
API call: void (*sg_aux_join_recv_func) (task *tp, sockaddr_un *saddr, sockaddr_un *gaddr, if_addr *ifap, int dsproto)
Function: generated when an IGMP join indication is received on an interface and the IGMP protocol does not own the interface

MBR Aux Prune Alert—
API call: void (*sg_aux_prune_recv_func) (task *tp, sockaddr_un *saddr, sockaddr_un *gaddr, int dsproto)
Function: Generated when an IGMP prune indication is received on an interface and the IGMP protocol does not own the interface.

MBR Aux Ex-Join alert:
API call: int mbr_send_gmp_exjoin_alert(sockaddr_un *gaddr, sockaddr_un *saddr, if_addr *ifap)
Function: Generated by an LGMM the group membership mode is exclude on soe interface when it is determined that hosts that had desired to not receive group traffic from a specific source now desire such traffic or when other reasons as determined by the LGMM occur such that Aux Ex-Prune state should be canceled. This alert is sent to the component that owns the interface by the MBR model.

MBR Ex-Prune Alert
API call: int mbr_send_gmp_exprune_alert(sockaddr_un *gaddr, sockaddr_un *saddr, if_addr *ifap)
Function: Generated by an LGMM when group membership mode is EXCLUDE on some interface and it is determined that no hosts on the interface desire to receive group traffic form a specific source. This alert is sent to the component that owns the interface by the MBR module.

MBR Get Neighbors Alert—
API call: void (*get_neighbors_func) (sockaddr_list_head *h, if_addr *ifap)
Function: Generated in response to DVMRP Ask Neighbors 2 message

MBR DR Status Alert—
API call: int (*get_dr_status_func) (sockaddr_un *dr, if_addr *ifap)
Function: Generated when another MBR component requests Designated Router (DR) election status.

MBR send group ExPrune Alert
API call: int mbr_send_gmp_exprune_alert(sockaddr_un *gaddr, sockaddr_un *saddr, if_addr *ifap)
Function: An LGMM calls this function when the group membership mode is EXCLUDE on some interface and it is determined that no hosts on that interface desire to receive group traffic from a specific source. The Aux Ex-Prune alert is delivered to the component that owns the interface by the MBR module.

MBR Send Group ExJoin Alert
API call: mbr_send_gmp_exjoin_alert(sockaddr_un *gaddr, sockaddr_un *saddr, if_addr *ifap)
Fucntion: An LGMM calls this function when the group membership mode is EXCLUDE on some interface and it is determined that hosts that previously had desired to not receive group traffic from a specific source now desire such traffic or when other reasons as determined by the LGMM occur such that Aux Ex-Prune state should be canceled.
   The MBR API for registration includes:

Registration for MBR alerts
Function: Register callback routines for MBR alerts

API call:

mbr_register(task *tp,

sg_creation_recv_func sg_creation_recv,
sg_wrongif_recv_func sg_wrongif_recv,
sg_join_recv_func sg_join_recv,
sg_prune_recv_func sg_prune_recv,
grp_join_recv_func grp_join_recv,
grp_prune_recv_func grp_prune_recv,
grp_aux_join_recv_func grp_aux_join_recv,
grp_aux_prune_recv_func grp_aux_prune_recv,
get_neighbors_func get_neighbors,
sg_deletion_recv_func sg_deletion_recv,
get_dr_status_func get_dr_status,
aux_exjoin_recv_func aux_exjoin_recv,
aux_exprune_recv_func aux_exprune_recv,
exjoin_recv_func exjoin_recv,
exprune_recv_func exprune_recv,
sg_include_join_recv_func sg_include_join_recv,
sg_include_prune_recv_func sg_unclude_prune_recv)

mbr_unregister
Function: unregister component for MBR alerts
Call: void mbr_unregister(*task)

mbr_grp_register_interest
Function: unregister interest in a group prefix
Call: void mbr_grp_register_interest(sockaddr_un *gaddr, sockaddr_un *gmask, task *tp);

Mbr_grp_unregister_interest
Function: unregister a component's interest in a group prefix
Call: void mbr_grp_unregister_interest(sockaddr_un *gaddr, sockaddr_un *gmask, task *tp);

mbr_sg_register_exinterest
Function: Register exclusion interest. This function is typically invoked when all hosts on component-owned interfaces that indicated a desire to receive data address to G, then also indicate a desire not to receive data from Source s. The purpose for registering Ex-interest is to trigger Ex-Prune alerts to be delivered to other components.
Call: int mbr_sg_register_exinterest(task *tp, sockaddr_un *gaddr, sockaddr_un *saddr)

Mbr_sg_unregister_exinterest
Function: Unregister exclusion interest. If the registration is found in the registration database, it is removed. If the registration is not found in the database, the operation is considered successful.
Call: int mbr_sg_unregister_exinterest(task *tp, sockaddr_un *gaddr, sockaddr_un *saddr)

mbr_sg_register_include
Function: A component calls this function whenever it contributes an interface to the outgoing interface list for (S,G) thon which the LGMM indicates (S,G) INCLUDE state exists on the interface. This function sends the MBR (S,G) Include Join alert. This alert is only sent if RPF_Interface(S) is known and if RPF_Interface(S) is owned by a multicast component.
Call: int mbr_sg_register_include(task *tp, sockaddr_un *saddr, sockaddr_un *gaddr)

mbr_sg_unregister_include
Function: A component calls this function while processing an MBR Aux Prune alert when a source is given and the interface would be contributed to the outgoing interface list for (S,G).
Call: int mbr_sg_unregister include(task *tp, sockaddr_un *saddr, sockaddr_un *gaddr)
   APIs to Support Multicast Routing Table Data Storage

Embodiments of this invention include an API to store Multicast routing table data, including the following API calls:

Install MBR entry
Function: create an (S,G) entry in the MRT as well as the MFC (both kernel and other MFCs associated with this MBR module).
Call: void mbr_create_sg(task *tp, sockaddr_un *saddr, sockaddr_un *gaddr, const source_t *src, if_addr *iif, const upstream_t *up)

Delete MBR entry
Function: delete an (S,G) in the MRT as well as the MFC
Call: void mbr_delete_cache(task *tp, sockaddr_un *gaddr, sockaddr_un *gmask, sockaddr_un *saddr, sockaddr_un *smask, if_addr *iif, int notify_owner)

Add OIF to (S,G) entry where G=Group
Function: add an Outbound Interface (OIF) to a OIF list where G=Group
Call: int mbr_sg_add_downstream(sockaddr_un *saddr, sockaddr_un *gaddr, if_addr *ifap)

Add OIF to (S,G) entries covered by a prefix
Function: This function adds an OIF to the OIF list of all (S,G) equal to or greater than: (saddr/smask, gaddr/gmask)
Call: void mbr_add_downstream(sockaddr_un *saddr, sockaddr_un *smask, sockaddr_un *gaddr, sockaddr_un *gmask, if_addr *ifap);

Delete an OIF from an (S,G) entry
Function: This function deletes an OIF from an (S,G) entry corresponding to the (saddr,gaddr) in both the MBR MRT and the MFC (kernel and associated MFCs)
Call: void mbr_sg_delete_downstream(sockaddr_un *saddr, sockaddr_un *gaddr, if_addr *ifap)

Delete an OIF from (S,G) entry where G=group
Function: Components running multicast protocols can call this to delete an OIF from the OIF list of all (S,G) for a given Group, G.
Call: void mbr_grp_delete_downstream(sockaddr_un *gaddr, if_addr *ifap)

Delete an OIF form (S,G) Entries covered by a prefix
Function: Deletes the OIF corresponding to ifap from all (S,G) entries equal or greater than the mask: (saddr/smask,gaddr/gmask)
Call: void mbr_delete_downstream(sockaddr_un *saddr, sockaddr_un *smask, sockaddr_un *gaddr, sockaddr_un *gmask, if_addr *ifap)

Locate Upstream Information for an Address
Function: Search the Multicast RIB (MRIB) for the route. If no such route exists or an interface to the route cannot be determined, this function returns a null. Otherwise it returns a filled in upstream_t data structure. The upstream_t data structure is filled in with: interface leading to src_addr, pointer to routing entry (rt_entry), mask for route covering source (srcmask), up_wrongif (wrong interface—set to zero), and nbr—number of hops. The nbr variable will be set to 0 if local, or the address of the next_hop toward the source.
Call: upstream_t *mbr_locate_upstream(sockaddr_un *src_addr)

Reset MBR information
Function: Resets the upstream neighbor associated with the (S,G) in the MBR's MRT module to nbr.
Call: int mbr_reset_nbr(sockaddr_un *gaddr, sockaddr_un *saddr, sockaddr_un *nbr)
   APIs to Handle Interfaces Associated with the MBR

Embodiments of this invention has the following API calls to handle interfaces:

Claim interface for a component
Function: This API call requests ownership of the interface identified by ifap for component task tp.
Call: int mbr_set_iftask(if_addr *ifap, task *tp)
   Unclaim interface
Function: This API call releases ownership of the interface identified by ifap from component task tp.
Call: int mbr_set_iftask(if_addr *ifap, task *tp)
   Reset Incoming Interface (IIF)
Function: This API resets the Incoming Interface (IIF) of the specified (S,G) entry.
Call: int mbr_reset_iif(sockaddr_un *gaddr, sockaddr_un *saddr, if_addr *ifap)

Retrieve interface owner
Function: This API call has a method to retrieve the component that owns the interface ifap. If no component owns the interface, the function returns a NULL.
Call: task *mbr_get_iftask(if_addr *ifap)

Retrieve interface owner protocol number
Function: This API returns the protocol number of the component that owns the interface.
Call: int mbr_get_ifproto(if_addr *ifap)

Get the component task
Function: This API returns the component tasks structure based on a component id or zero if no atsk is found
Call: task *mbr_get_component(int compid)

Get the component ID
Function: This API call returns the component ID based on the component task pointer.
Call: int mbr_get_compid(task *tp)

Get DR status
Function: This API calls returns the identity of the Designated router on an interface.
Call: int mbr_get_DR_status(sockaddr_un **dr, if_addr *ifap)

Get DVMRP neighbors
Function: This API causes the MBR to deliver the MBR get_neighbors alert to the owner of ifap. If the owner of ifap did not register to receive the MBR get_neighbors alert, the alert is not delivered.
Call: void mbr_get_neighbors(struct sockaddr_list_head *list, if_addr *ifap)
   SG Table Data Structure Function

The invention has a method for a SG Table (SGT) container for storing information about (S,G) pairs that has the property that given S₁ one may obtain all pairs (S₁,G₁) . . . (S₁,Gₙ) in O(N) time where N is the number of groups. An embodiment of the SGT is represented by the following code:

typedef sgt_t{

| | |
|---|---|
| task * | tp; |
| ptree_t * | sources; |
| sgt_entry_alloc_fn | entry_alloc; |
| sgt_entry_free_fn | entry_free; |
| GQ_HEAD(,sgt_walk_) | walks; |

} sgt_t;
Where:
tp - the task that allocates the sgt_t
sources - a patricia trie that stores sgt_source_t structures
entry_alloc - function used to allocate data stored in container
entry_free - function used to deallocate data stored in container
walks - list of iterators for the container
sgt_source_t:

The following data structure is a container for the unique (S,G) entries that all share the same source address using the SGT concept.

typedef sgt_sour {

| | |
|---|---|
| pnode_t * | node; |
| sockaddr_un * | address; |
| ptree_t * | groups; |

} sgt_source_t;
node - the storage in the sources patricia trie for this sgt_source_t
address - the address of the source
groups - a patricia trie that stores sgt_group_t structures
sgt_group_t:

This data type represents an unique (S,G) entry in the SGT

typedef sgt_group_{—} {

| | |
|---|---|
| pnode_t * | node; |
| sockaddr_un * | address; |
| sgt_source_t * | source; |
| void * | data; |

} sgt_group_t;
node - the storage in the groups patricia trie for this sgt_group_t
address - the address of the group
source - the source
data - a container for data to store at this entry
sgt_walk_t

This data type represents an instance of an iterator for an SGT container that is used to find enteries in the SGT.

typedef sgt_walk_ {

| | |
|---|---|
| GQ_LINK(sgt_walk_) | wlink; |
| pwalk_t * | swalk; |
| pwalk_t * | gwalk; |

} sgt_walk_t;
wlink - the entry in the walks linked list for this instance
swalk - the interator for the sgt_source_t structures
gwalk - the iterator for the sgt_group_t structures

typedef void * (*sgt_entry_alloc_fn) (task *tp, void *data)
tp - task that allocated the sgt_t
data - the data to duplicate and store in the container

typedef void (*sgt_entry_free_fn) (task *tp, void *data)
tp - task that allocated the sgt_t
data - the data to free

In the foregoing specification, embodiments of the invention have been described with reference to numerous specific details that may vary from implementation to implementation. The specification and drawings are, accordingly, to be regarded in an illustrative rather than an restrictive sense.

1. A router on a packet switched network comprising:
two or more network interfaces coupling the router to the packet switched network;
a first one or more software modules operative on the router to communicate with a first plurality of nodes on the packet switched network via one or more protocol independent multicasting protocols;
a second one or more software modules operative on the router to communicate with a second plurality of nodes on the packet switched network via one or more local group membership protocols;
a third one or more software modules facilitating communication between the first one or more software modules and the second one or more software modules via a canonical software interface;
a cache storing a plurality of pairs, each of the plurality of pairs including a source identifier for a source node on the network, and one or more identifiers for one or more nodes from the first plurality of nodes and the second plurality of nodes, wherein the first one or more software modules and the second one or more software modules are operative to store and retrieve the plurality of pairs in the cache via the canonical software interface.

2. The router of claim 1, wherein the one or more protocol independent multicasting protocols include one or more of PIM-SM, PIM-DM, DVMRP, and PIM-SSM.

3. The router of claim 1, wherein the one or more local group membership protocols include one or more of IGMPv2, IGMPv3, MLDV.

4. The router of claim 1, wherein the router is operative to concurrently preserve the full functionality of the one or more protocol independent multitasking protocols and the one or more local group membership protocols.

5. The router of claim 4, wherein the canonical software interface ensures consistency of the plurality of pairs in the cache.

6. The router of claim 1, wherein the canonical software interface comprises an application programming interface.

7. The router of claim 1, wherein the router is operative to provide an “include” operation, whereby the router is configured to receive messages from one or more nodes on the packet-switched network indicating that such one or more nodes shall receive messages addressed to a group of one or more addresses on the packet switched network by one or more source nodes on the packet switched network, and wherein the router is operative to update the plurality of pairs in the cache in response in order to identify such one or more source nodes with the group of one or more addresses.

8. The router of claim 1, wherein the router is operative to provide an “exclude” operation, whereby the router is configured to receive messages from one or more nodes on the packet-switched network indicating that such one or more nodes shall not receive messages sent from one or more addresses on the packet-switched network.

9. The router of claim 8, wherein the router is operative to update the plurality of pairs in the cache in response to the exclude operation.

10. The router of claim 1, the router further comprising:
one or more modules for assigning to each of the pairs in the plurality of pairs in the cache and each network interface, a software module for routing network traffic corresponding to the pair, wherein the software module is assigned to the pair and the network interface in real-time.

11. The router of claim 1, wherein the packet-switched network is in communication via one or more IP protocols.

12. The router of claim 11, wherein the one or more IP protocols include IPv4 and IPv6.
